(19) United States
(12) Patent Application Publication
(10) Pub. No.: US 2025/0060021 A1
(43) Pub. Date: Feb. 20, 2025

(54) HORIZONTAL VIBRATION ISOLATION SYSTEM WITH MULTI-TENSIONING WIRES HAVING QUASI-ZERO ADJUSTABLE STIFFNESS IN THREE AXES

(71) Applicant: BOGAZICI UNIVERSITESI, Istanbul (TR)

(72) Inventors: Cetin YILMAZ, Istanbul (TR); Mehmet Utku DEMIR, Istanbul (TR)

(73) Assignee: BOGAZICI UNIVERSITESI, Istanbul (TR)

(21) Appl. No.: 18/725,820

(22) PCT Filed: Dec. 28, 2022
(86) PCT No.: PCT/TR2022/051647

§ 371 Date: Jul. 1, 2024

(30) Foreign Application Priority Data
Dec. 30, 2021 (TR) 2021/021812

(51) Int. Cl. F16F 15/04

(52) U.S. Cl. CPC F16F 15/04

(57) ABSTRACT

An isolation system is provided. The isolation system is configured to isolate the translational vibration in the directions of an X-axis and a Y-axis and the torsional vibration around a Z-axis by being positioned between a ground and a load. The isolation system includes at least one base platform that can be associated with the ground, at least one load bearing platform that can be associated with the load, a plurality of beams positioned between said base platform and said load bearing platform in a symmetric way that there is equal distance and equal angle between them with respect to the central axis, multiple tensioning wires positioned adjacent to each beam or beam group so that there is at least one for that beam or beam group in order to bring the said base platform and said load bearing platform closer together.

### CROSS-REFERENCE TO THE RELATED APPLICATIONS

This application is the national phase entry of International Application No. PCT/TR2022/051647, filed on Dec. 28, 2022, which is based upon and claims priority to Turkish Patent Application No. 2021/021812, filed on Dec. 30, 2021, the entire contents of which are incorporated herein by reference.

### TECHNICAL FIELD

The invention is a system that can be used in the field of vibration isolation in general, and it is related to at least one isolation system configured to isolate a possible translational vibration in the direction of an X-axis and a Y-axis and the torsional vibration around a Z-axis by being positioned between a ground and a load in order to protect vibration-sensitive mechanical, optical and electronic systems and devices specifically used in industrial activities and laboratory studies from vibration.

### BACKGROUND

In the current technology, there is no system in which the stiffness of horizontal vibration isolation systems is adjusted to values close to zero passively and frictionlessly according to the weight of the load carried by using a multi-wire tensioning mechanism. Most of the systems with horizontal stiffness adjustment feature are either active and require the use of sensors, actuators, control circuits and electrical power, or although they are passive, they exhibit decreases in isolation performance at low frequencies as a result of friction and backlash that occur during vibrations due to their articulated structures.

There are few vibration isolation systems in the literature that possess the ability to adjust horizontal stiffness and operate passively and without friction, and they have some negative features. In such systems, since the torsional natural frequency is higher than the translational natural frequency, it has been determined that the vibration isolation performance of the system at low frequencies is worse in the torsional axis.

The application numbered US20140048989A1 known in the literature requires the coordinated use of two or four spring compression mechanisms in order to adjust the horizontal stiffness. Stiffness adjustment cannot be made from a single center. In addition, due to the fact that the horizontal torsional stiffness of the support spring carrying the load is higher than the translational stiffness, it is understood that the isolation performance for the rotational vibrations of the system will be lower than for translational vibrations, especially in cases where low mass loads are carried. Stiffness adjustment with the multi-wire tensioning principle is not available in this patent.

Application U.S. Pat. No. 5,178,357A known in the literature provides horizontal stiffness adjustment with polymeric rubber materials. It is understood that in low amplitude vibrations, frictions arising from these materials will increase the horizontal stiffness, cause local resonances at low frequencies and decrease the vibration isolation performance.

As a result, all the above-mentioned problems have made it necessary to make an innovation in the related technical field.

### SUMMARY

The present invention is related to an isolation system in order to eliminate the above-mentioned disadvantages and bring new advantages to the related technical field.

An object of the invention is to present an isolation system used to isolate vibrations coming from horizontal (parallel to the ground) directions.

Another object of the invention is to provide an isolation system in which tension adjustment of all tensioning wires can be made with a single tensioning mechanism.

Another object of the invention is to present an isolation system that can isolate vibrations at very low frequencies in three axes even if the mass of the carried load changes.

Another object of the invention is to provide an isolation system with a wide vibration isolation frequency range.

Another object of the invention is to present an isolation system that can isolate vibration at very low frequencies in three axes and can operate in a frictionless (without including articulated structures) manner when exposed to vibration after the stiffness is manually adjusted to quasi-zero values in all three axes depending on the mass of the carried load.

In order to achieve all the objects that are mentioned above and that will come forth from the detailed description below, the invention is at least one isolation system configured to at least partially isolate the translational vibration in the directions of an X-axis and a Y-axis and the torsional vibration around the Z-axis by being positioned between a ground and a load.

Accordingly, the novelty of the invention lies in that it comprises at least one base platform that can be associated with the ground, at least one load bearing platform that can be associated with the load, a plurality of beams or beam groups positioned between said base platform and said load bearing platform in a symmetric way that there is equal distance and equal angle between their central axes with respect to the central axis of the isolation system, multiple tensioning wires positioned adjacent to each beam or beam group so that there is at least one for that beam or beam group in order to bring the said base platform and said load bearing platform closer together to provide that the beams or beam groups are compressed at least partially under force and accordingly, change the translational and torsional natural frequencies of the isolation system, and at least one tensioning mechanism for tensioning said tensioning wires together so that they remain parallel to the beams. Thereby, even if the weight of the load changes, an isolation system is obtained in which multiple beam stiffness adjustments are made by adjusting the tension of multiple tensioning wires and the horizontal vibrations are isolated in all three axes.

The characteristic of a possible embodiment of the invention is that said tensioning mechanism includes at least one adjusting member for adjusting the tension of the tensioning wires.

The characteristic of another possible embodiment of the invention is that it comprises at least one threaded rod that can move vertically depending on the adjusting member, an internal threaded hollow member that provides the vertical movement of the said threaded rod, and at least one channel associated with the said threaded rod on the base platform.

The characteristic of a possible embodiment of the invention is that the said channel allows only the vertical movement of the threaded rod, and not its rotation.

The characteristic of another possible embodiment of the invention is that the tensioning mechanism comprises at least one arm for the transfer of force from the said adjusting member to the tensioning wires.

The characteristic of another possible embodiment of the invention is that said arm is provided in at least one curved form.

The characteristic of another possible embodiment of the invention is that the lever is provided in at least one lever form.

The characteristic of another possible embodiment of the invention is that it comprises at least one cross flexible member positioned at least between the arm and the base platform and between the arm and the adjusting member.

The characteristic of another possible embodiment of the invention is that it comprises at least one vertical flexible member positioned at least between the arm and the base platform and between the arm and the adjusting member.

The characteristic of another possible embodiment of the invention is that it comprises at least one guide roller between the adjusting member and the tensioning wire.

The characteristic of another possible embodiment of the invention is that the said beams or beam groups are arranged at equal distances and at equal angles between their central axes with respect to the center of the isolation system, and it comprises multiple tensioning wires located adjacent to each beam or beam group, at least one for each beam or beam group.

The characteristic of another possible embodiment of the invention is that the said beams are grouped side by side in two or more numbers and contain a tensioning wire in the center of each group, and these multiple tensioning wires are located at equal distances and at equal angles between them with respect to the center of the isolation system.

### BRIEF DESCRIPTION OF THE DRAWINGS

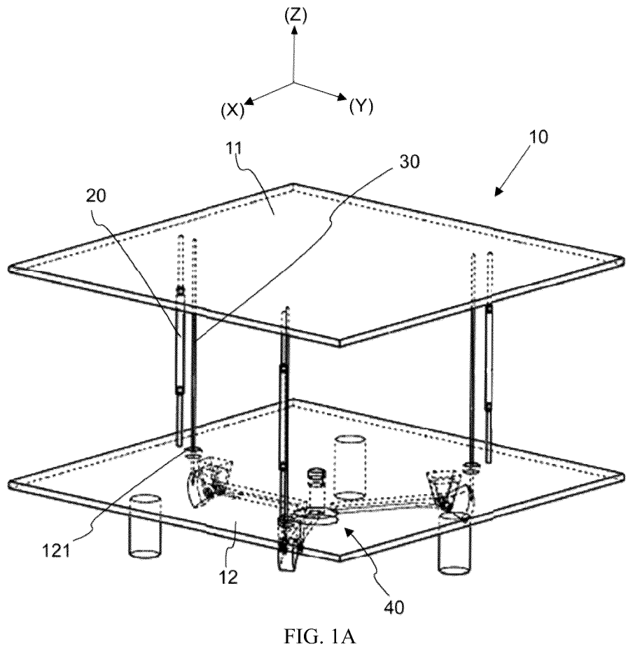

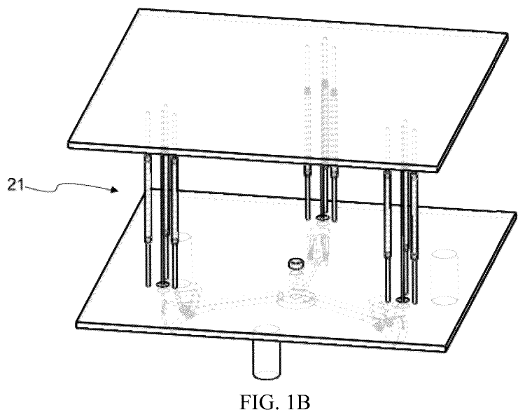

In FIG. 1A, a representative perspective view of the isolation system of the invention, in which the beams are located at equal distances and at equal angles with respect to the center of the system, is given.

In FIG. 1B, a representative perspective view of the isolation system of the invention, in which the beam groups are positioned at equal distances and at equal angles with respect to the center of the system, is given.

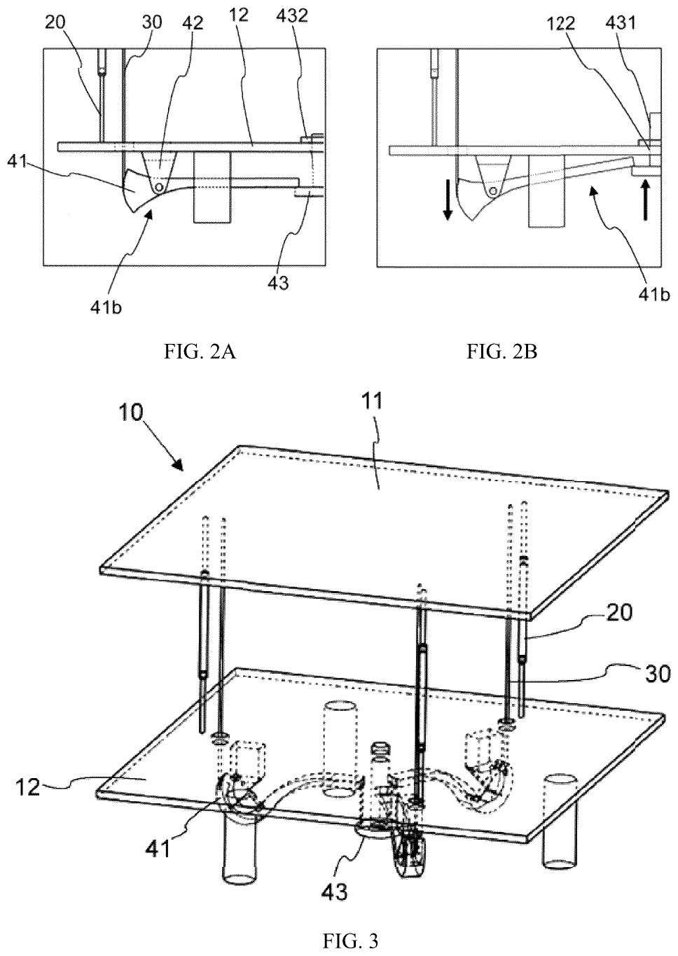

In FIG. 2A, a representative side view of the tensioning mechanism in the isolation system of the invention is given.

In FIG. 2B, a representative side view of the movement of the tensioning mechanism in the isolation system of the invention is given.

In FIG. 3, the perspective view of the tensioning mechanisms in the isolation system of the invention, as connected to the base platform with cross flexible members, is given.

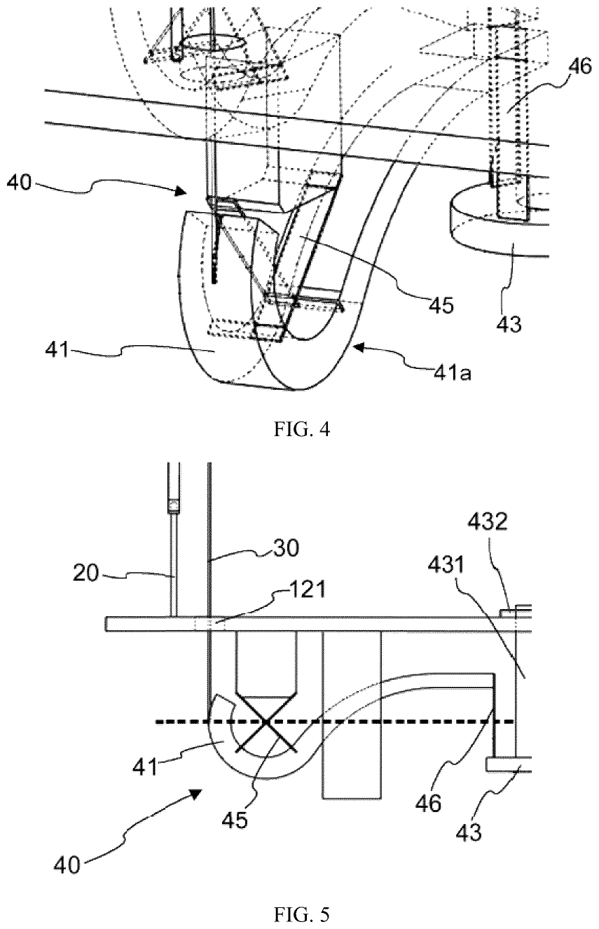

In FIG. 4, a zoomed-in perspective view of a tensioning mechanism in the isolation system of the invention, as connected to the base platform with cross flexible members is given.

In FIG. 5, the side view of a tensioning mechanism in the isolation system of the invention, as connected to the base platform with cross flexible members, is given.

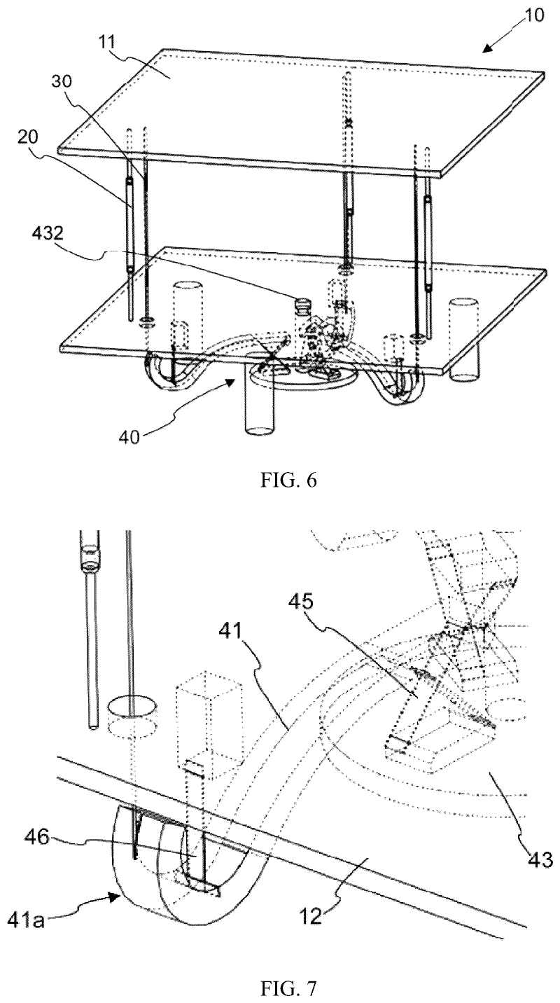

In FIG. 6, the perspective view of the tensioning mechanisms in the isolation system of the invention, as connected to the base platform with vertical flexible members, is given.

In FIG. 7, a zoomed-in perspective view of a tensioning mechanism in the isolation system of the invention, as connected to the base platform with a vertical flexible member, is given.

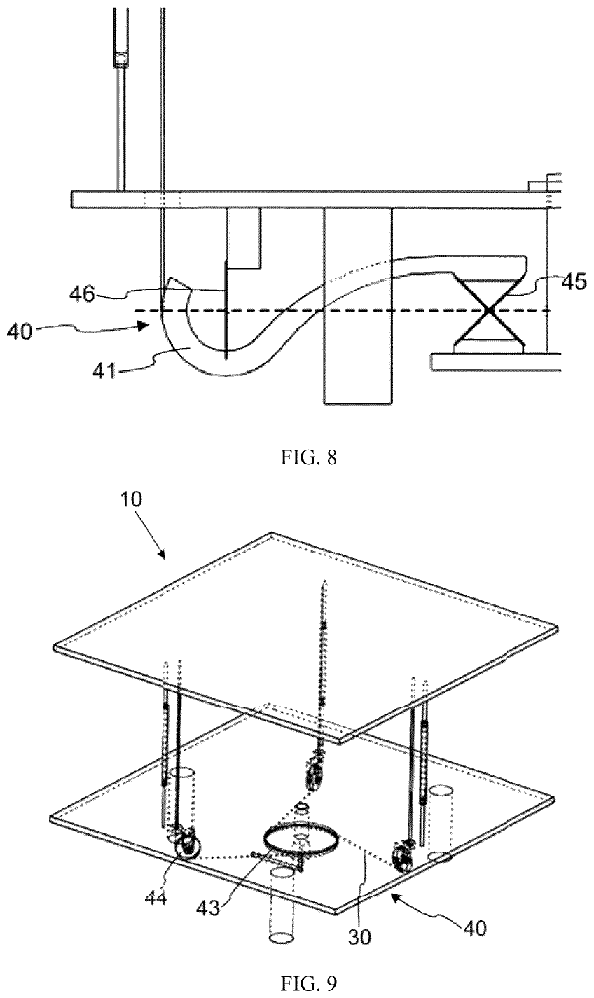

In FIG. 8, the side view of a tensioning mechanism in the isolation system of the invention, as connected to the base platform with a vertical flexible member, is given.

In FIG. 9, the perspective view of the tensioning mechanism in the isolation system of the invention, pulling the wires over the guide rollers, is given.

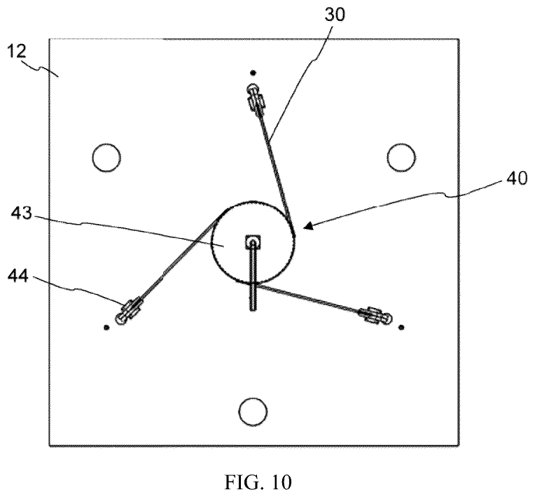

In FIG. 10, the bottom view of the tensioning mechanism in the isolation system of the invention, pulling the wires over the guide rollers, is given.

### DETAILED DESCRIPTION OF THE EMBODIMENTS

In this detailed description, the subject of the invention is described only for the better understanding of the subject and in the way to create no limiting effect whatsoever.

The invention is related to an isolation system (10). The isolation system (10) of the invention is used to isolate vibrations which are horizontal, that is, parallel to the ground. In the isolation system (10), it is enabled that the translational and torsional natural frequencies (hence the translational and torsional stiffnesses) to be adjusted together. The isolation system (10) can be configured to have adjustable stiffness in the X-axis (X), Y-axis (Y) and Z-axis (Z). The isolation system (10) can preferably be used to protect vibration sensitive mechanical, optical and electronic measuring devices used in industrial activities and laboratory studies from vibration.

In FIG. 1A, a representative perspective view of the isolation system (10) of the invention is given. Accordingly, there is at least one base platform (12) and at least one load bearing platform (11) in the isolation system (10). The mentioned base platform (12) and the load bearing platform (11) are positioned essentially parallel to each other. The base platform (12) is the part where the isolation system (10) is associated with the ground. The mentioned load bearing platform (11) enables the positioning of the load on the isolation system (10). In order to provide vibration isolation, multiple beams (20) are positioned between the base platform (12) and the load bearing platform (11). The mentioned beams (20) are essentially placed in the direction of gravity and can be an elastically bendable element with variable cross-sections (thin-thick-thin). The cross-sectional areas of the beams (20) have rotational symmetry. The translational and torsional stiffnesses of the isolation system (10) can be adjusted depending on the axial compressive load applied to the beams (20). In particular, the beams (20) between the base platform (12) and the load bearing platform (11) are provided in three pieces with equal distance between them and equal angles with respect to the center. However, the number of beams (20) is not limited to this, but can also be in different numbers in the isolation system (10) depending on the need.

In the vibration isolation system, there is at least one tensioning wire (30) adjacent to each beam (20) between the base platform (12) and the load bearing platform (11). In another possible embodiment of the system, the beams (20) are grouped side by side in two or more, with at least one tensioning wire (30) at the center of each beam group (21). In FIG. 1B, a representative perspective view of the isolation system (10) of the invention, in which the beams (20) are grouped next to each other in threes, is given. The mentioned tensioning wire (30) can be tensioned between the base platform (12) and the load bearing platform (11) by means of at least one tensioning mechanism (40). The amount of axial compressive force applied to the beams (20) is due to the total weight of the load bearing platform (11) and the carried load, and the tensile forces applied by the tensioning wires (30) positioned adjacent to the beams (20). The amount of axial compressive force on the beams (20) can be increased with the tension forces that occur when the tensioning wires (30), which are connected to the load bearing platform (11) at their upper end, are slightly pulled from their lower ends. The tensioning wires (30) used in the isolation system (10) can be in the form of single or multi-strand steel rope or solid wire. The tensioning mechanism (40) used in the isolation system (10) is a mechanical structure designed to change the tension of the tensioning wires (30). The object of the tensioning mechanism (40) is to bring the horizontal natural frequencies of the isolation system (10) quasi-zero by changing the tension of the tensioning wires (30). While a manually adjusted tensioning mechanism (40) can be used in the isolation system (10), an automatically adjusted tensioning mechanism (40) can also be used in alternative structures.

The tensioning mechanism (40) is located on the ground-facing side of the isolation system (10) in the preferred embodiment of the invention. There is an arm (41) structure on the tensioning mechanism (40) to be associated with each tensioning wire (30). Said arms (41) are used for tensioning the tensioning wires (30). The reason why the tensioning mechanism (40) is positioned on the side of the base platform (12) preferably facing the ground is to ensure that the tensioning wires (30) on which the adjusting member (43) exerts force through the arms (41) are longer than the beams (20), thus reducing the amount of force on the tensioning wires. The arms (41) used in the tensioning mechanism (40) can be designed in different types to adjust the tension of the tensioning wires (30). Holes (121) can be found on the base platform (12) in order to associate the tensioning wires (30) with the arms (41). The tensioning wires (30) are passed through these holes (121) and associated with the arms (41). The arms (41) are gathered towards each other in the center of the base platform (12) with essentially equal distances between them. The arms (41) in the tensioning mechanism (40) are associated with at least one adjusting member (43). Said adjusting member (43) is preferably positioned under the base platform (12) and is configured to exert compression on the arms (41). In order to do this, the adjusting member (43) is configured to move vertically with respect to the base platform (12). When the subject is detailed, the adjusting member (43) can be formed from at least one threaded rod (431) and at least one internal threaded hollow member (432). Said threaded rod (431) is associated with at least one channel (122) provided in the center of the base platform (12). Preferably, in order for the adjusting member (43) positioned on the ground side of the base platform (12) to be able to stretch the tensioning wires (30) by means of the arms (41), it should be moved upwards without turning and fixed after the adjustment. In order to perform these functions, an internal threaded hollow member (432) may be needed. When the internal threaded hollow member (432), which receives force from the base platform (12), is rotated, the threaded rod (431) is moved vertically in the channel (122). In order to achieve this function, the part of the channel (122) and the threaded rod (431) that is at least partially inside the channel (122) should be prismatic. In addition, there should be no backlash between the surface of the channel (122) and this prismatic surface of the threaded rod (431). In this way, when the adjusting member (43) is moved in the vertical direction, the arms (41) can adjust the tension of the tensioning wires (30) by taking force from the adjusting member (43). The adjustment process is facilitated (41) as the tensioning mechanism (40) can stretch all the tensioning wires (30) from a single center.

In FIGS. 2A and 2B, a representative side view of the tensioning mechanism (40) in the isolation system (10) of the invention is given. Accordingly, in a possible embodiment of the invention, the arm (41) in the tensioning mechanism (40) can be provided in a lever form (41b). Said lever form (41b) is one where one side of the arm (41) is curved and allows the tensioning wire (30) to move around a supporting piece (42) like a scale. In FIG. 2A, a horizontal view of the arm (41) provided in lever form (41b) is given when the tensioning wires (30) are not tensioned. On the other hand, In FIG. 2B, it is seen that by moving the adjusting member (43) vertically, the arm (41) in the lever form (41b) is rotated at least partially around the mentioned supporting piece (42) and axially stretches the tensioning wires (30). Thanks to this developed tensioning mechanism (40), the tensioning wires (30) are held in their vertical positions and are tensioned in equal amounts by a single tensioning mechanism (40).

Between FIGS. 3 and 5, representative views of the tensioning mechanism (40) in the isolation system (10) of the invention are given. Accordingly, in the tensioning mechanism (40), the arms (41) can have a curved form (41a). In the said curved form (41a), the arms (41) provide that the center of the cross flexible members (45) and the midpoint of the vertical flexible member (46) are horizontally aligned. The arms (41) can adjust the tension of the tensioning wires by taking power from the adjusting member (43) through their curved forms (41a). For this, the arms (41) are at least partially rotated by means of the adjusting member (43). It is important that the tensioning wires (30) remain in vertical position during the tensioning process. For this reason, the parts of the arms (41) where the tensioning wires (30) are connected have the shape of a circle. Thereby, the vertical position of the tensioning wires (30) is maintained. There is at least one cross flexible member (45) and at least one vertical flexible member (46) on the tensioning mechanism (40). Said cross flexible member (45) is positioned close to the tensioning wires (30), and said vertical flexible members (46) are positioned close to the adjusting member (43). The vertical flexible member (46) is positioned between the adjusting member (43) and the arm (41). The cross flexible member (45) is positioned between the arm (41) and the base platform (12). Cross flexible members (45) preferably allow rotation without intersecting each other. The vertical flexible members (46) that are at least partially compressed as a result of the upward movement of the adjusting member (43) bend and rotate the arms (41) relative to the center of the cross flexible members (45), and thus the tensioning wires (30) at the other end of the arms (41) are stretched. The diagonal positioning of the cross flexible members (45) provides that this cross flexible member (45) system has high translational stiffness in horizontal and vertical axes, while it has low torsional stiffness in its vertical symmetry plane. In addition, since the cross flexible member (45) system has high torsional stiffness in the horizontal plane, it enables the arms (41) to rotate by remaining parallel to the vertical plane. In this developed tensioning mechanism (40), the fact that the center of the cross flexible members (45) and the vertical flexible member (46) are on the same level provides that the arms (41) rotate with minimum lateral movement during the deflection of the cross flexible members (45). In this way, the tensioning wires (30) are maintained at almost right angles, keeping the angles of the tensioning wires (30) with their extension directions negligibly low.

In FIGS. 6 and 8, a representative view of the tensioning mechanism (40) in the isolation system (10) of the invention is given. Accordingly, there is at least one cross flexible member (45) and at least one vertical flexible member (46) in the tensioning mechanism (40). Said vertical flexible member (46) is positioned between the arm (41) and the base platform (12). And the said cross flexible member (45) can be positioned in multiple numbers in such a way that there is a predetermined angle between the arms (41) and the adjusting member (43). In this way, after the adjustment of the adjusting member (43) a balanced load distribution is provided to the tensioning wires (30) and beams (20).

In this embodiment, the cross flexible members (45) allow rotation without intersecting each other. Since the torsional stiffness of the cross flexible members (45) relative to the center axis perpendicular to the vertical symmetry plane is low compared to the translational stiffness in the horizontal and vertical axes, the cross flexible members (45) rotate and flex as a result of the vertical threaded rod (431), allowing the arms (41) to rotate. Vertical flexible members (46) positioned close to the tensioning wires (30), on the other hand, provide this rotation movement by flexing. In order to minimize the lateral movement during the rotational movement of the arms (41), the center of the cross flexible members (45) and the midpoint of the vertical flexible member (46) are positioned at the same level.

In FIGS. 9 and 10, a representative view of the tensioning mechanism (40) in the isolation system (10) is given. Accordingly, the tensioning wires (30) on the tensioning mechanism (40) are directly associated with the adjusting member (43). By rotating the adjusting member (43) around itself, the tension of the tensioning wires (30) can be adjusted by wrapping the extensions of the tensioning wires (30) around the adjusting member (43). In order to do this, each tensioning wire (30) is associated with at least one guide roller (44) provided on the base platform (12). Said guiding rollers (44) prevent the tensioning wires (30) from rubbing against the base platform (12) while wrapping around the adjusting member (43). For this, the tensioning wire (30) is passed around the guide roller (44), which comprises a roller that reduces friction.

In a possible embodiment of the invention; if the adjusting member (43) is associated with a worm gear system, a self-locking system can be obtained. Thereby, the tensions in the tensioning wires (30) remain constant after adjustment. Since there is a tension force on both horizontal and vertical wires on each guide roller (44), compression is created on the shafts of these rollers and a possible backlash between shaft and bearing is eliminated. Therefore, the system can oscillate without backlash after adjustment.

The common feature of all structures of the isolation system (10) is that it can simultaneously tension multiple tensioning wires (30) by the same amount with a single point adjustment. In addition, in all these tensioning mechanisms (40), the tensioning wires (30) remain perpendicular to the base platform (12) while being stretched. In all these systems, the tensions in the tensioning wires (30) remain constant since the adjustment systems are fixed after the tension adjustment is completed. With this developed multi-wire tensioning method, even if the weight of the carried load changes, vibration isolation is provided at low frequencies in the X-axis (X), Y-axis (Y) and around the Z-axis (Z) of the system. In addition, the isolation system (10) is fixed after being adjusted, and it is possible to obtain vibration isolation in very wide frequency ranges, since the system operates without friction when exposed to vibration.

For these objects, tensioning mechanisms (40) that provide the isolation system (10) to conduct vibration isolation in multiple axes at very low frequencies are developed. Thanks to the developed multi-wire tensioning mechanisms (40), it is ensured that all tensioning wires (30) are tensioned simultaneously and equally in a single setting. With these tensioning mechanisms (40) used, the amount of axial compressive forces on the elastic beams (20) are changed by the tension forces applied to the tensioning wires (30) depending on the weight of the load carried. As a result of these force changes, the horizontal stiffnesses of the beams (20) are changed. When the mass of the carried load decreases, the translational and torsional stiffnesses of the system are decreased by increasing the tension forces, and thus the translational and torsional natural frequencies can be kept at low values so that they are very close to each other. In addition, instead of the developed manual tensioning mechanism (40), an automated tensioning mechanism (40) can be used to measure the carried load mass with a load cell or similar sensor, and by means of an actuator, the tension forces in the tensioning wires (30) can be brought to the desired values. In this way, an adaptive tensioning mechanism (40) can also be obtained. In the proposed isolation system (10), it is ensured that the natural frequencies of translation in the X-axis (X) and Y-axis (Y) directions and torsion around the Z-axis (Z) direction are adjusted to very close and low values, even if the mass of the carried load changes.

The protection scope of the invention is given in the attached claims, and it cannot be limited to what has been described as an example in this detailed description under any circumstances. It is understood that a person with the skill in the art can put forth similar embodiments in the light of what has been described above, without departing from the main theme of the invention.

### REFERENCE NUMERALS IN THE FIGURES

10 Isolation system
11 Load Bearing Platform
12 Base Platform
121 Hole
122 Channel
20 Beam
21 Beam Group
30 Tensioning Wire
40 Tensioning Mechanism
41 Arm
41a Curved Form
41b Lever Form
42 Supporting Piece
43 Adjusting Member
431 Threaded Rod
432 Internal Threaded Hollow Member
44 Guide Roller
45 Cross Flexible Member
46 Vertical Flexible Member

What is claimed is:

1. An isolation system, configured to isolate a translational vibration in directions of an X-axis and a Y-axis and a torsional vibration around a Z-axis by being positioned between a ground and a load, wherein in order to provide a vibration isolation even if a weight of the carried load changes, the isolation system comprises;
a base platform allowed to be associated with the ground,
at least one load bearing platform allowed to be associated with the load,
a plurality of beams or a beam group provided with equal distances between central axes of the plurality of beams and equal angles with respect to a center of the isolation system, between the base platform and the load bearing platform,
a plurality of tensioning wires positioned adjacent to each of the plurality of beams or the beam group, providing that there is at least one for the plurality of beams or the beam group, in order to bring the base platform and the load bearing platform more adjacent together, to provide that the plurality of beams are compressed at least partially under force and accordingly, translational and torsional natural frequencies of the isolation system are changed.

2. The isolation system according to claim 1, wherein the isolation system comprises at least one tensioning mechanism for tensioning the plurality of tensioning wires parallel to the plurality of beams and with an equal amount.

3. The isolation system according to claim 1, wherein cross-sectional areas of the said plurality of beams have a rotational symmetry.

4. The isolation system according to claim 1, wherein the isolation system comprises at least one adjusting member to be allowed to adjust a tension of the plurality of tensioning wires of a tensioning mechanism.

5. The isolation system according to claim 4, wherein the isolation system comprises
at least one threaded rod on the adjusting member,
at least one internal threaded hollow member, wherein the internal threaded hollow member ensures a vertical movement of the threaded rod and a fixation of the threaded rod after adjustment, and
at least one channel associated with the threaded rod on the base platform.

6. The isolation system according to claim 4, wherein the isolation system comprises at least one arm-lever for a transmission of force from the adjusting member of the tensioning mechanism to the plurality of tensioning wires.

7. The isolation system according to claim 6, wherein a surface of the arm in contact with the tensioning wire is circular in shape and the surface of the arm is fixed to the base platform by means of a supporting piece from a center of a circle.

8. The isolation system according to claim 6, wherein the arm is provided in at least one curved form.

9. The isolation system according to claim 6, wherein the arm is provided in at least one arm form.

10. The isolation system according to claim 4, wherein the isolation system comprises at least one cross flexible member positioned in at least one between an arm and the base platform and between the arm and the adjusting member.

11. The isolation system according to claim 4, wherein the isolation system comprises at least one vertical flexible member positioned in at least one between an arm and the base platform and between the arm and the adjusting member.

12. The isolation system according to claim 10, wherein a center of the cross flexible member connected to the arm and a center of a vertical flexible member are horizontally aligned.

13. The isolation system according to claim 4, wherein the isolation system comprises at least one guide roller between the adjusting member and the tensioning wire.

14. The isolation system according to claim 6, wherein the isolation system comprises at least one cross flexible member positioned in at least one between the arm and the base platform and between the arm and the adjusting member.

15. The isolation system according to claim 6, wherein the isolation system comprises at least one vertical flexible member positioned in at least one between the arm and the base platform and between the arm and the adjusting member.

16. The isolation system according to claim 11, wherein a center of the cross flexible member connected to the arm and a center of the vertical flexible member are horizontally aligned.

17. The isolation system according to claim 14, wherein a center of the cross flexible member connected to the arm and a center of a vertical flexible member are horizontally aligned.

18. The isolation system according to claim 15, wherein a center of the cross flexible member connected to the arm and a center of the vertical flexible member are horizontally aligned.
